(19) United States
(12) Patent Application Publication
(10) Pub. No.: US 2020/0366401 A1
(43) Pub. Date: Nov. 19, 2020

(54) METHOD AND APPARATUS FOR JAMMING SIGNAL CONTROL BASED ON THE RF ENVIRONMENT

(71) Applicant: Electronic Warfare Associates, Inc., Herndon, VA (US)

(72) Inventor: Plamen Vanchev, Suwanee, GA (US)

(73) Assignee: Electronic Warfare Associates, Inc., Herndon, VA (US)

(21) Appl. No.: 16/864,600

(22) Filed: May 1, 2020

Related U.S. Application Data
(60) Provisional application No. 62/849,538, filed on May 17, 2019.

(51) Int. Cl. H04K 3/00

(52) U.S. Cl. CPC H04K 3/46; H04K 3/45

(57) ABSTRACT

An RF front end may determine a RF energy ratio between environmental RF energy and a jamming signal. An RF energy analysis engine may implement an adaptive AGC processing to adjust a jamming signal level to perform a jamming operation on a target RF signal based on a relationship between the RF energy ratio and a threshold.

### CROSS REFERENCE TO RELATED APPLICATION

This application is based on and derives the benefit of the filing date of U.S. Provisional Application No. 62/849,538, filed May 17, 2019. The entire content of this application is herein incorporated by reference in its entirety.

### FIELD OF THE INVENTION

This application relates to controlling jamming signal level based on RF energy assessment in the target band (channel).

### BACKGROUND

Wireless communication is vulnerable to jamming. Targeted jamming can deny and deceive vital government, commercial and personal wireless links. That vulnerability exists for both friendly and adversary entities. From a friendly prospective, adversary entity Radio Frequency systems (RF systems) may be targeted in the environment in which those RF systems reside.

Targeting of adversary RF systems is made more difficult because of the variability of background noise as well as the multitude of surrounding wireless standards. These variables provide enormous challenges for effective and efficient jamming of any radio communication.

### SUMMARY

This disclosure describes the dynamic aligning of friendly jamming signal levels, based upon a harnessing method to a particular adversary radio system. The method may include assessing the maximum likelihood of effectiveness of denial and deception service for an adversary radio system and aligning parameters (e.g., power level and/or other factors) for a friendly jamming system. The factors used to determine a potential RF energy level, such as thermal noise floor, RF pollution, broadcasting signals, spurious signals, etc. over the time interval, may be adaptive and may be adjusted as needed.

An adaptive friendly transmitter gain control (AGC) method may be implemented using maximum likelihood criteria for the effectiveness of denial and deception based on the assessed ratio between RF energy in the operation environment and the jamming signal level. The method is based on adjusting jamming signal power depending on the mission that needs to be accomplished. For example, the jamming signal level may be controlled to be above a statistical threshold for a particular target system in a complex RF environment. An immediate benefit is to minimize the high noise floor effect to signal-to-jamming ratio while improving effectiveness and coverage in congested radio environments.

These illustrative aspects and features are mentioned not to limit or define the invention, but to provide examples to aid understanding of the inventive concepts disclosed in this application. Other aspects, advantages, and features of the present invention will become apparent after review of the entire application.

### BRIEF DESCRIPTION OF THE DRAWINGS

The features, aspects, and advantages of the present disclosure are better understood when the following Detailed Description is read with reference to the accompanying drawings.

FIG. 1 is an block diagram illustrating example operations of a jamming system at various levels of a hierarchical infrastructure with potential field deployment according to an embodiment of the disclosure.

FIG. 2 is an example of RF energy variation in the time domain according to an embodiment of the disclosure.

FIG. 3 is a method of performing jamming signal level control according to an embodiment of the disclosure.

### DETAILED DESCRIPTION

A potential friendly jamming may dynamically align a output signal level based upon a harnessing method to a particular adversary radio system. The method may assess the maximum likelihood of effectiveness of denial and deception service for a targeted adversary radio system and may align parameters such as transmitted power, signal bandwidth, power spectral density, duty cycle, etc. to a friendly jamming system.

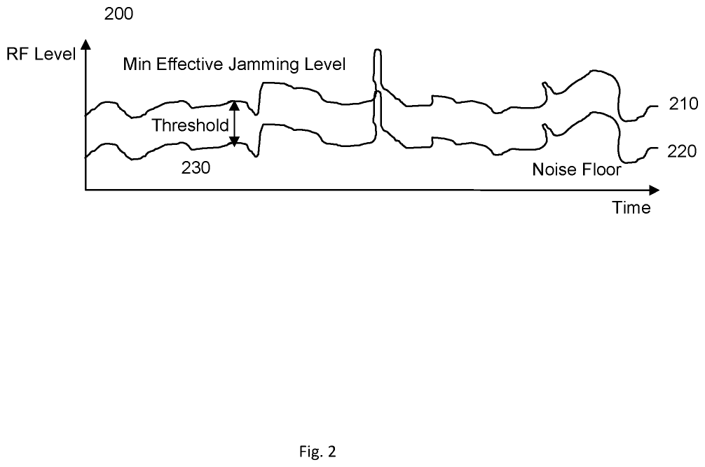

Some embodiments described herein may implement adaptive transmitter automatic gain control (AGC) through a method using maximum likelihood criteria for the effectiveness of denial and deception based on the assessed RF energy following variation in time domain (e.g., as is shown in FIG. 2, described in detail below). The jamming signal level may be adjusted above a statistical threshold for a particular target system while the system is working in a complex RF environment. Accordingly, a high noise floor effect to signal-to-jamming ratio may be utilized while improving effectiveness in congested radio environments. In some cases, energy corresponding to a higher noise floor may be added to the jamming signal. A high noise level may degrade the performance of the receiver being jammed. Therefore, a small jamming signal may be effective to render the receiver nonresponsive.

The adaptive transmitter gain control may be embedded directly into jamming equipment. In this case a monitoring system may collect RF environmental data (RF survey). Based on the results, the jamming transmitter output power may be adjusted to achieve the target performance.

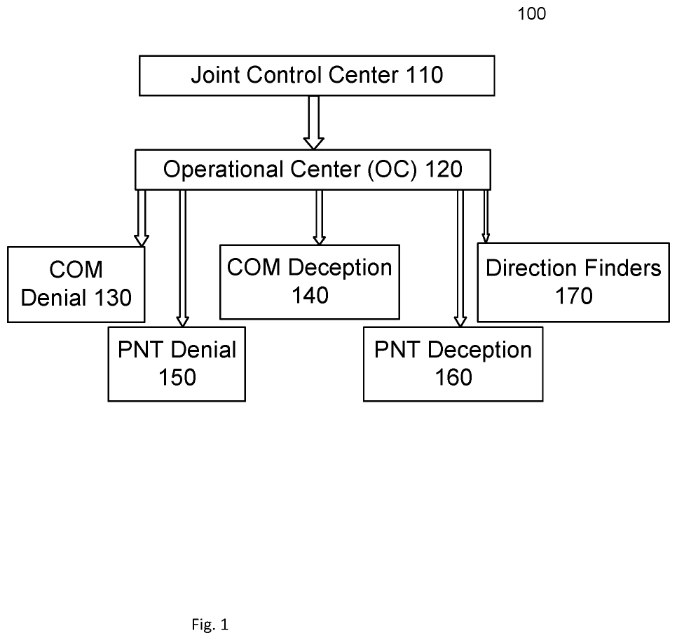

The adaptive method may also be delivered by a cloud-based control system utilizing a remote Software Defined Radio (SDR) management system (API based, for example). In this case, a management system may control more than one jamming transmitter. One example of a possible cloud based system may implement a jamming system over the hierarchical infrastructure presented in FIG. 1 (described in detail below) where the method may be implemented either in the operation joint center or in a center for remote control of jamming equipment. This system may provide at least the following capabilities:
a. Operator managed configuration settings
b. Smart power consumption management
c. Toggled Enable/Disable (this feature controls based upon an operator tactical EW template)
d. Throughput Management
e. RF parameter Management (Tx and Rx characteristics, Smart Antenna, BW Control, Duty Cycle, etc.)
f. Smart algorithm management align to the mission (control in time domain)

FIG. 1 illustrates a configuration of a jamming system 100 over the vertical according to an embodiment of the disclosure. Jamming system 100 may include a joint control center 110, which may include one or more processors or other computing devices that are either novel or known to those or ordinary skill in the art. The joint control center 110 may control other elements of system 100. For example, joint control center 110 may manage one or more operation centers (OCs) 120, which may include one or more processors or other computing devices that are either novel or known to those or ordinary skill in the art, as well as jamming hardware and/or software that are either novel or known to those or ordinary skill in the art. One OC 120 is shown for ease of illustration, but in other embodiments, multiple OCs 120 may be present. Each OC 120 may be in communication with joint control center 110 through a network connection that is either novel or known to those or ordinary skill in the art or hardwired or otherwise directly connected. These operation centers 120 may control entire jamming missions that may be separated based on the following targets, for example:
a. Communication:
   i. Denial 130
   ii. Deception 140
b. Positioning, Navigation and Timing (PNT):
   i. Denial 150
   ii. Deception 160
c. Directional Finders 170

Jamming operations may have different purposes, and the methods described herein may be implemented to any equipment with required capabilities depending on configuration.

FIG. 2 is an example 200 of RF environment variation in the time domain according to an embodiment of the disclosure. As shown, there may be a threshold level 230 between a minimum effective jamming RF level 210 and a noise floor RF level 220. The minimum effective jamming RF level 210 and noise floor RF level 220 may vary over time because of inconsistency of the RF sources such as the following:
a. Noise Sources
b. Atmospheric Variation
c. Cosmic Noise
d. Additional Equipment:
   i. Spurious Signals
   ii. Harmonics
   iii. In-Band Emissions
e. Power Grid, etc.

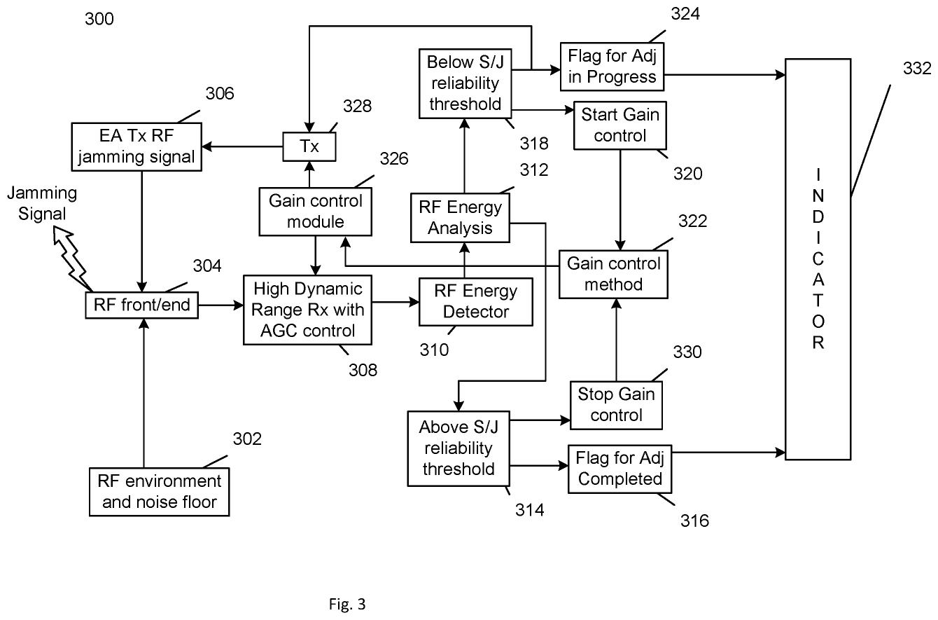

FIG. 3 is a method 300 of performing jamming signal level control according to an embodiment of the disclosure. Method 300 may be performed by joint control center 110 and/or one or more operation centers 120, alone or in combination. This figure represents an example of the proposed adaptive control method as deployed in jamming equipment. The radio environment is monitored by an RF energy collecting device 302 that may be an antenna or other system. The signal is received and processed by the RF front/end 304.

In the RF front/end 304, the received signal may be compared with a fraction of a broadcasted signal (Tx Signal) 306. FR front/end may pass the ratio between these compared signals to RF stage with high dynamic range 308. RF stage with high dynamic range 308 may normalize the signal and minimize unwanted spikes and/or other variables. This normalization may be either in the time domain (variation over time) or in the frequency domain (variation in frequency). The normalized signal may go to RF Energy Detector 310. RF Energy Detector 310 may quantify the RF ratio from the input of the front/end 304.

The measured RF Energy may go to further analysis 312, where the signal may be compared with a reliability threshold. This threshold may be set up in the beginning of the jamming mission and may be either dynamic (for a mobile system, for example) or static (for a stationary system, for example). This threshold may be user-specified or may be a default or automatically selected threshold. One or more processors, ASICs, FPGAs, DSPs, computers, cloud based computers, or mobile devices may be employed to perform the analysis. When the measured signal is above the predetermined threshold level 314, this may indicate that the jamming signal level may provide effective jamming. For example, the device that performed the analysis may activate a flag 316 indicating that the jamming signal level may provide effective jamming, and the gain control method may keep the last known state.

When the measured RF energy ratio is below the reliability threshold 318, the dynamic control determination may kick off 320 a jamming broadcasting control method 322. For example, the dynamic control determination may activate flag 324 to indicate that the system is in tuning (adjustment) mode. The gain control method 322 may send a signal to gain control module 326 to increase the Tx signal from transmitter 328. This may be done because the gain control module 326 increases the amplification of the jamming signal. The increased signal may be compared in the RF front/end 304 with received environmental noise, and the new ratio may go to the same path described above for signal processing.

The gain control method will stop when the Tx signal is above the reliability threshold. This may initiate a new flag 330 that stops the gain control. This may also and change the indicator 332.

In general, gain control method 322 may be closed-loop feedback regulating an amplifier or chain of amplifiers. The algorithm control may be implemented either with analog or digital components that may even include cloud based control utilizing remote management features.

Analog control may be implemented based on the gain control adjustment. When the ratio is below the threshold level setup in RF energy Analysis Block 312, a voltage change may be triggered that will increase the TX gain and will make the TX signal stronger. At the same time, the flag may be generated at 324 indicating that adjustment is in progress. The control signal may settle down when the ratio is above the reliability threshold. A flag indicating that control is over may be set at 316.

In the digital realm, gain control may be implemented as follows. When the ratio is below the reliability threshold, gain control may be kicked off and at the same time, the flag indicating the system is in adjustment mode may be sent out 324, perhaps even to the cloud that may initiate gain control. The gain control system may send out a digital stream (digital number) that adjusts the TX gain, and the gain control system may change the output signal level of jamming signal. When gain control is managed by the cloud, a remote control management system (API based for example) may send the control signal through an appropriate interface (wired or wireless IP based such as fiber, CAT, cellular, WAN, PAN, Lan, etc.) which also may initiate the gain control of the TX signal. When the ratio reaches the threshold, the gain control system may stop the gain change, and the gain control system may keep the last known value until the ratio changes.

Frequency analysis may also be employed, especially for jamming an RF tactical radio system. The equipment may analyze the target signal in the frequency domain to determine which frequency will be targeted. In this case, gain control may be implemented in two stages. In the first stage, the frequency domain may be searched for target frequencies. In the second stage, once the target frequencies are determined, the system may start RF energy detection based on the gain control described above.

### Benefits of Disclosed Embodiments

At least some of the embodiments described above may provide at least one of the following technical benefits.

Greater jamming effect because
a. Jamming planning is based on S/J ratio vs. absolute power level
b. Jamming profile is based on RF target communication system
c. Jamming becomes scalable by friendly entities based upon actual tactical considerations

Greater efficiency in employment of jamming system in complex RF environment

Better power efficiency of the denial and deception process
a. Increase the efficiency of battery powered jammers
b. Ability to manage power consumption based on the environment/tactical consideration
c. Adaptive Tx power level control process based upon real time noise data

For friendly Test & Evaluation/Training perspective
a. Better management/delivery of threat generation capabilities
b. Automation of threat generation with less operator training required
c. Minimize operator influence over the friendly jamming signal

Easier management of own team
a. Can assign different jamming missions for the same team because of automation
b. Jamming effects easily selectable

Mitigate possible jamming of own signals
a. System can be designed to minimize jamming of own signals
b. Easier to employ in complex RF environments

Highly adaptive for testing and training environments

Provides much truer environments for test and training purposes. The impact of the jamming system over the target system may be evaluated in a lab or during a training mission. This allows the gain control to be tuned based on the maximum efficiency relative to the target system.

### CONCLUSION

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A system for jamming a radio frequency (RF) signal, comprising:
an RF front end configured to determine a RF energy ratio between environmental RF energy and a jamming signal; and
an RF energy analysis engine configured to implement an adaptive AGC processing to adjust a jamming signal level to perform a jamming operation on a target RF signal based on a relationship between the RF energy ratio and a threshold.

2. The system of claim 1, wherein the RF front end is further configured to compare the RF energy with a fraction of the jamming signal from an RF jamming signal transmitter, and
further comprises a receiver with automatic gain control (AGC) configured to measure the RF energy and minimize spikes associated with the RF energy.

3. The system of claim 1, further comprising an RF energy detector configured to receive and quantify the RF energy ratio from the RF front end to generate a measured RF energy ratio.

4. The system of claim 1, wherein the adaptive AGC processing comprises comparing the measured RF energy ratio to the threshold by the RF energy analysis engine.

5. The system of claim 4, wherein, in response to a comparison result that the measured RF energy ratio is below the threshold, the adaptive AGC processing comprises:
generating a first flag to indicating an adjustment mode; and
initiating a gain control process to increase the jamming signal level by increasing the measured RF energy ratio up to the threshold.

6. The system of claim 4, wherein, in response to a comparison result that the measured RF energy ratio is equal to or above the threshold, the adaptive AGC processing further comprises:
initiating a second flag to stop a gain control process and keep the adjusted jamming signal level until the RF energy changes.

7. The system of claim 1, wherein the adaptive AGC processing further comprises aligning parameters comprising transmitted power, signal bandwidth, power spectral density, duty cycle associated with the jamming signal.

8. The system of claim 1, wherein the adaptive AGC processing further comprises adding energy corresponding to a noise floor to the jamming signal.

9. The system of claim 1, wherein the adaptive AGC processing is implemented by the one or more processors in communication with a remote control management system through at least one network.

10. The system of claim 1, further comprising RF energy collecting equipment, coupled to the RF front end, including one or more antennas and configured to monitor a radio environment.

11. A method for jamming a radio frequency (RF), the method comprising:
determining, by an RF front end, a RF energy ratio between environmental RF energy and a jamming signal; and
adjusting a jamming signal level to perform a jamming operation on a target RF signal based on a relationship between the RF energy ratio and a threshold.

12. The method of claim 11, further comprising:
comparing, by the RF front end, the RF energy with a fraction of the jamming signal from an RF jamming signal transmitter;
measuring the RF energy by a receiver with automatic gain control (AGC); and
minimizing, by the receiver with automatic gain control (AGC), unwanted spikes and other variables associated with the RF energy.

13. The method of claim 11, further comprising:
receiving and quantifying, by an RF energy detector, the RF energy ratio from the RF front end to generate a measured RF energy ratio.

14. The method of claim 11, further comprising comparing the measured RF energy ratio to the threshold.

15. The method of claim 14, wherein, in response to a comparison result that the measured RF energy is below the threshold, the adaptive AGC processing comprises:
generating a first flag to indicating an adjustment mode; and initiating a gain control process to increase the jamming signal level to the threshold.

16. The method of claim 14, further comprising, in response to a comparison result that the measured RF energy is equal to or above the threshold, initiating a second flag to stop a gain control process and keep the adjusted jamming signal level until the input RF energy changes.

17. The method of claim 11, further comprising aligning parameters comprising transmitted power, signal bandwidth, power spectral density, duty cycle associated with the jamming signal.

18. The method of claim 11, further comprising adding energy corresponding to a noise floor to the jamming signal.

19. The method of claim 11, wherein the adaptive AGC processing is implemented in communication with a remote control management system through at least one network.

20. The method of claim 11, further comprising monitoring an RF environment with RF energy collecting equipment comprising one or more.
